(19) United States
(12) Patent Application Publication
(10) Pub. No.: US 2007/0263181 A1
(43) Pub. Date: Nov. 15, 2007

(54) Method for Operating a Mobile Device for Projecting Image Data, and Mobile Projector Device

(75) Inventors: Ralf Hying, Munchen (DE); Marco Werner, Munchen (DE)

Correspondence Address: BELL, BOYD & LLOYD, LLP, P.O. Box 1135, CHICAGO, IL, 60690, US

(73) Assignee: Ben Q Mobile GmbH & Co.OHG, Muenchen (DE)

(21) Appl. No.: 10/598,475

(22) PCT Filed: Jan. 21, 2005
(86) PCT No.: PCT/EP05/50268

§ 371 Date: Jun. 1, 2007

(30) Foreign Application Priority Data
Mar. 4, 2004 (DE) 102004010710.6

(51) Int. Cl. G03B 21/00

(52) U.S. Cl. 353/121

(57) ABSTRACT

A method is disclosed for operating a mobile device for projecting image data. At least one variable representing the current projection environment is determined by a first light source at least once during a current projection phase. At least one parameter of the current projection phase is adapted on the basis of the determined variable. A mobile projector device operating the disclosed method is also described herein.

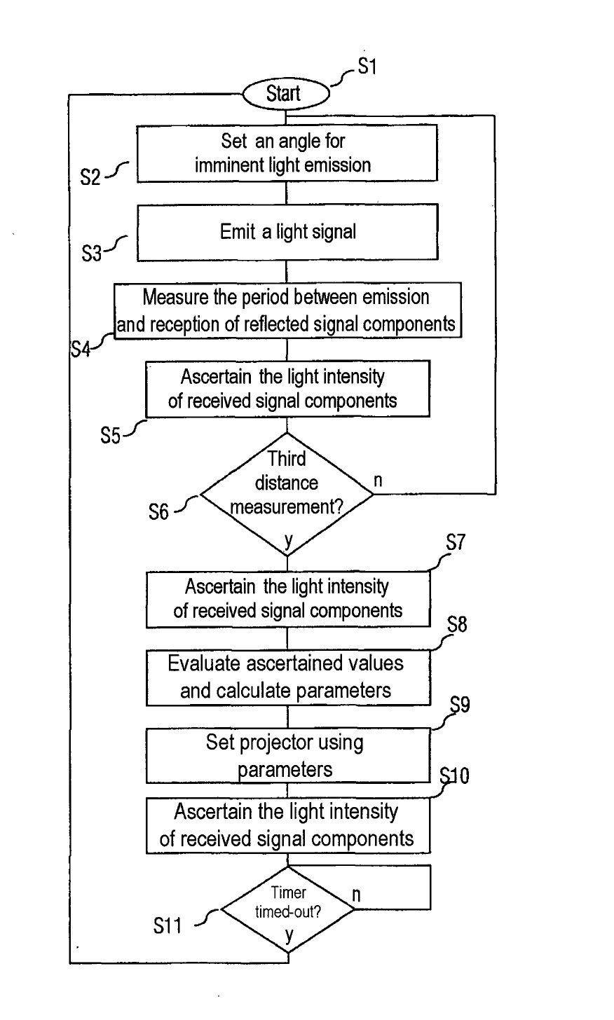

### FIELD OF TECHNOLOGY

The present disclosure relates to a method for operating a mobile device for projecting image data and to a mobile projector device.

### BACKGROUND

As is known, electrical appliances are subject to continued miniaturization. Especially in mobile appliances, such as mobile or cordless telephones, continuous efforts are being made to reduce the size to a minimum. It is furthermore known that such appliances increasingly have functions going far beyond the scope of normal telephony. Examples of such functions are radio reception, storing and playing audio data, recording image date and recording video data. Not only appliances in mobile telephony are subject to this development, however, but also appliances in data processing. Projectors, for example, which are also known as beamers, are being marketed with ever smaller dimensions. It is an obvious step, therefore, to also use these mini-projectors in future in conjunction with mobile telephones and, for example, to project image data stored in the mobile telephone onto a suitable surface, at any desired location.

One disadvantage here is that, in contrast to normal projector uses, where the projectors are usually positioned at a specially prepared location and oriented towards a specially provided projection surface, the parameters such as position of the projector and projection surface always vary for a mini-projector of the stated type.

### SUMMARY

Under an exemplary embodiment, a mobile device projects image data using a first light source, wherein at least one variable representing the characteristic of the current projection surroundings is ascertained at least once during a current projection phase, within at least one parameter of the current projection phase being matched on the basis of the ascertained variable.

One advantage of the embodiment is that the matching to changing characteristics of the projection surroundings allows a mobile device to provide the best possible projection independently of the current location where it is used. Even if the devices are operated at the same location and the surrounding characteristics change nevertheless, a consistent projection quality can be achieved.

In general, one distance measurement using light emission is preferably used if, for example, the projector device has a camera, in particular a CCD camera, which can detect any distortion in a projection generated by the light emission, with the result that conclusions in terms of the distance can be drawn from the distortion using mathematical methods.

Furthermore, alternative or complementary embodiment may provide at least three distance measurements carried out at least once during a current projection phase, wherein the measurements in each case are carried out based on an emitted first signal and with the first signals being emitted at different emission angles. At least one second signal is emitted, and then the intensity of reflected components of the second signal and the brightness of the surroundings are measured. Finally, at least one parameter of the current projection phase is matched based on at least one result of those ascertained by the abovementioned steps.

Precise detection of projection conditions affecting the projection quality, and the characteristics of the projection surface permit ever greater accuracy in successive matching of appliance characteristics to current conditions. Accordingly, it becomes possible to ascertain the so-called “normal” to the currently applicable projection surface by measuring at least three distances at which the emission angle is different for each measurement and to match, in a further step, the projection direction of the projecting appliance such that the projection direction and the normal to the currently applicable projection surface are mutually parallel; i.e. the angle between them is zero, with the result that image distortion, so-called keystoning, is ruled out. A type of intermediate evaluation of these measurements leading to another distance measurement in order to permit more precise determination of the necessary orientation of the projection is also possible according to this inventive method. It is furthermore possible to draw conclusions about the surface composition and the reflectivity of the currently selected projection surface by emitting at least one second signal and measuring the intensity of reflected components of this signal. This, too, can lead, in a subsequent step, to matching of the corresponding parameters of the projection or, if it is difficult to use the current projection surface, for example to a corresponding signal output to the user. The optimization of projection parameters according to the exemplary embodiment is finally also assisted by measuring the brightness of the surroundings of the projection device's current location such that conclusions for matching can also be drawn from them.

Preferably, the first and/or second signal is/are generated in the exemplary process by emitting light. This has the advantage that elements already contained in the projector, such as the first light source, can be used and thus costs can be saved. The image quality is very good if laser light is used. As an alternative, or complementary thereto, however, if the aim is to save costs, for example, light-emitting or laser diodes which are better for this purpose, can also be used.

It is also feasible for light sources to be used as second sources for implementing the method. For example, light sources can be used which do not need a warming-up phase, so that a measurement is carried out very quickly and during the evaluation, for example the warming-up phase of the first light source responsible for the projection. In addition, sources contributing special characteristics useful in the method can be used as second light sources. Use of a laser permits very precise distance measurement, for example.

A very inexpensive variant for the detection of reflected signal components is to use a photodiode, because photodiodes are generally widely available mass-produced items and are therefore a very cost-effective means. As an alternative, a charge coupled device CCD can be used for this purpose, which permits particularly accurate detection of reflected signal components.

It is also feasible, as an alternative embodiment, to measure the distance by emitting sound, in particular at frequencies in the ultrasound range which is inaudible to the user, instead of using a further light source. This procedure can be advantageous if, for example, the projector device is used together with a sound-emitting appliance, such as a mobile radio telephone, so that devices in the mobile telephone can be used for emitting and receiving and thus costs can be reduced. The fact that no further devices therefore need to be installed in the projector also ensures that the dimensions of the projector can be kept small.

Irrespective of the type of signal source, the distance can be measured by ascertaining the period from the time of emission to the arrival of the correspondingly reflected signal components.

As another alternative, the distance can also be measured by evaluating interference resulting from reflected signal components, which leads to more accurate results and can be used as the basis for further evaluations.

If the intensity is measured using devices provided for the detection of reflected signal components without previously emitting signals, this has the advantage that elements already available in the projector can be used to implement the method; a further advantage results from the fact that major elements of the routines necessary for carrying out the distance measurement can be used for measuring the intensity and only minor additions or changes need to be made to these routines, so that, ultimately, the storage space needed for a program carrying out the method of the invention can be kept very small.

In a further advantageous embodiment, at least one further distance measurement is carried out if curvature of the projection surface is indicated based on an evaluation of the results ascertained in the at least three distance measurements or by user input. This ensures very accurate successive matching to the characteristics of the currently selected projection surface.

If the steps of the exemplary embodiments are repeated at discrete time intervals during a current projection phase, matching to changes in the environmental parameters can be carried out in real time.

If the orientation of a vector, which is perpendicular to the projection surface and is referred to as the “normal”, is ascertained as a first result in the last step of the method according to the invention, and the projection axis is oriented such that it runs parallel to the normal, distortion of the projection image, also known as keystoning, is avoided.

Also, if the mean distance from the projector device to the projection surface is ascertained as the second result, and a focusing device for the projection device is manipulated based on this result such that optimum focusing is ensured, optimum sharpness of the image is also achieved.

Under the exemplary embodiments, if the projection device is switched off when the value of the mean distance has reached a maximum value set as a first threshold value, has reached a minimum value set as a second threshold value and/or when the angle between the projection axis and the normal corresponds to a maximum value set as a third threshold value, then the life of the projectors, in particular of the laser projectors, is prolonged because this results in a safety switch-off if, for example, a reasonable projection surface is no longer detected. This is generally the case if the distance is too great or if the angle between the projector and the projection surface exceeds the stated threshold values. If this is detected and switch-off occurs, it can be ensured that the laser beam does not unintentionally interfere with other projections or even endanger people by radiating laser light into their eyes. This development also has the advantage that, in the case of the distance being too short, the resulting intensity of the wider laser beam used for projection, which would be especially harmful when radiated into the eye on account of the distance being too short, with the power density in consequence being increased, is avoided. This also applies to projection appliances using conventional projector technology. In particular, this has the positive effect of saving energy as a primary factor, or only the disruptance of other people, however, since with conventional projector technology, a health risk can probably be ruled out.

The energy-saving effect can be additionally increased further if the brightness in the last step of the method of the invention is regulated at a minimum value based on the at least one result. This means that the light source only ever provides the degree of brightness and intensity that is just needed, so that energy resources are conserved, which, in the case of mobile appliances, would usually be batteries whose discharge is slowed down in this way.

The mobile projector device according to the present disclosure includes means for carrying out the method in the abovementioned way and thus represents one possible way to implement the method.

### BRIEF DESCRIPTION OF THE DRAWINGS

The various objects, advantages and novel features of the present disclosure will be more readily apprehended from the following Detailed Description when read in conjunction with the enclosed drawings, in which:

The sole FIGURE is a flowchart illustrating the operation of a mobile device for projecting image data according to an exemplary an embodiment.

### DETAILED DESCRIPTION

As can be seen, the exemplary method starts from an initial state in a first step S1 designated START. This state can occur for example once, namely at the start of the projection process, that is to say after the projector device has been switched on, or else can be repeated at regular intervals during the current projection phase after switch-on or after such initialization it is possible to react virtually in real time to changes in the environmental parameters, to position changes or to other changes affecting the projection parameters so that, despite any changes, the viewer experiences no changes in the display quality of the projected image.

Starting from the first step S1, the method begins in a second step S2 by setting an angle for an imminent light emission.

Starting from this second step S2, a light signal is transmitted in a third step S3 by a light source contained in the terminal. In a fourth step S4, the period between transmitting and receiving reflected components of this signal is measured. In addition, in a fifth step S5, the light intensity is ascertained using the received signals.

A check is thus performed as to whether a third distance measurement has already been carried out. This takes place in a sixth step S6. If three distance measurements have not yet been carried out, the method jumps back to the second step S2 and repeats the preceding steps. If the third distance measurement has already been carried out, however, the light intensity is ascertained in a seventh step S7, in which only light components of the surroundings, and thus the brightness of the surroundings, are ascertained because no signal previously been emitted.

In an eighth step S8, the ascertained values and the necessary parameters, which permit optimum projection which is matched to the current conditions, are then evaluated.

These parameters are set in a ninth step S9 and, in a tenth step S10, a timer is started, after whose time-out, eleventh step S11, the steps according to the invention are repeated starting with the first step S1.

The orientation of the projection plane relative to the projection axis is ascertained by emitting light signals in three different steps. In addition, the distance between projection surface and projector is also calculated hereby, and the reflectivity of the projection surface is determined. The further light intensity detection process is also used to detect the brightness of the surroundings as a final parameter of the current conditions.

The method according to the invention is therefore used to detect characteristics essential for the projection and to match them to the conditions described thereby with little effort.

As an alternative to checking at discrete time intervals, the method can also be implemented and carried out such that the measurements are taken in real time parallel to the current projection. This is possible in particular if the mobile projection appliance has a second signal source which emits signals and detects their reflections in the non-visible or inaudible range such that adaptation in real time is possible, thereby always achieving the advantages listed below:

Image equalization because the projection axis and the normal to the projection surface are always checked for parallelity, furthermore an optimum autofocus because the distance data can be evaluated in order to produce a sharp projection image, which is achieved in particular in conventional projectors by adjusting the optical elements.

A further advantage is the reduction in power consumption, because the distance of the projection surface from the projector and the brightness of the surroundings can be calculated from the reflectivity of the projection surface, in which the brightness is necessary to project an image which can be seen well and the controls are set such that exactly said minimum level of brightness is selected and no more power than necessary is consumed. Another power-conserving advantage is provided by a safety disconnect which can supplement the described example. This safety disconnect is activated if, for example, a distance measurement shows that no useful projection surface is available at that time, as is usually the case if the distance is too long or the angle between projector and projector surface exceeds specific values. It may also be activated, however, if the distance that is measured is too short. All these aspects mentioned leading to switch-off can be initiated via threshold value comparisons, within implementation of this method in a projector using laser light offering the advantage of protecting any people present against laser light striking their eyes, in addition to the advantage of saving power.

The invention is also distinguished by its simple design such that it can be used in any desired projection appliances.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-21. (canceled)

22. A method for projecting image data from a mobile device using a first light source, comprising:
determining at least one variable representing a characteristic of the current projection surroundings at least once during a current projection phase;
matching at least one parameter of the current projection phase with the determined variable to determine a projection quality of a surface.

23. The method as claimed in claim 22, wherein the distance is measured on the basis of light emission.

24. The method as claimed in claim 22, wherein at least three distance measurements are carried out during the determining step in which the measurement is in each case based on an emitted first signal and the first signals are emitted at different emission angles.

25. The method as claimed in claim 22, wherein at least one second signal is emitted, during the step of determining a current projection surrounding and the intensity of reflected components of the second signal is measured.

26. The method as claimed in claim 25, wherein the brightness of the surroundings is measured from the measured intensity.

27. The method as claimed in claim 24, wherein at least one of the first signal and the second signal is generated by emission of light.

28. The method as claimed in claim 27, wherein the light is emitted by a device for generating laser light.

29. The method as claimed in claim 27, wherein the light is emitted by at least one light-emitting diode.

30. The method as claimed in claim 27, wherein reflected signal components of the first signal and/or of the second signal are detected by a photodiode.

31. The method as claimed in claim 27, wherein reflected signal components of the first signal and/or of the second signal are detected by a charge coupled device (CCD device).

32. The method as claimed in claim 24 wherein the first signal and/or the second signal are/is generated by emission of sound, in particular at frequencies in the ultrasound range.

33. The method as claimed in claim 32 wherein a distance is measured by ascertaining the time from the emission to the arrival of reflected signal components.

34. The method as claimed in claim 32 wherein a distance is measured by evaluating interference resulting from reflected signal components.

35. The method as claimed in claim 26, wherein the brightness of the surroundings is measured by using devices intended for detecting reflected signal components without any signals previously having been emitted.

36. The method as claimed in claim 22, wherein if curvature of the projection surface is indicated by an evaluation obtained based on the result ascertained in the step of determining at least one variable, or by user input, at least one further distance measurement is carried out.

37. The method as claimed in claim 22, wherein the steps are repeated at discrete time intervals during a current projection phase.

38. The method as claimed in claim 22, wherein, during the step of determining a current projection surrounding, an orientation of a vector, which is perpendicular to the projection surface is determined as a first result, and a projection axis is oriented such that it runs parallel to the vector.

39. The method as claimed in claim 38, wherein, during the step of determining a current projection surrounding, a mean distance from the light source to the projection surface is determined as a second result, and a focusing of the light source is manipulated based on the result such that optimum focusing is ensured.

40. The method as claimed in claim 22, wherein the light source is switched off when the value of the mean distance has reached at least one of a maximum value set as a first threshold value, a minimum value set as a second threshold and when the angle between the projection axis and the vector corresponds to a maximum value set as a third threshold value.

41. The method as claimed in claim 26, wherein the brightness is regulated at a minimum value based on the at least one result.
